(19) United States
(12) Patent Application Publication
(10) Pub. No.: US 2022/0030298 A1
(43) Pub. Date: Jan. 27, 2022

(54) ADAPTIVE BITRATE VIDEO MANAGEMENT PLATFORM

(71) Applicant: ARRIS Enterprises LLC, Suwanee, GA (US)

(72) Inventor: Niranjan H. KOLHEKAR, Bangalore (IN)

(21) Appl. No.: 17/348,375

(22) Filed: Jun. 15, 2021

Related U.S. Application Data
(60) Provisional application No. 63/074,300, filed on Sep. 3, 2020.

(30) Foreign Application Priority Data
Jul. 21, 2020 (IN) 202031031243

(51) Int. Cl. H04N 21/438

(52) U.S. Cl. CPC H04N 21/438

(57) ABSTRACT

A cloud based video management platform capable of receiving multimedia content in any of a variety of different formats for delivery to consumers, and providing the content to the consumers.

### CROSS REFERENCE TO RELATED APPLICATIONS

This application claims the benefit of U.S. Provisional Patent Application Ser. No. 63/074,300 filed Sep. 3, 2020; this application claims priority to India patent application serial number 202031031243 filed Jul. 21, 2020.

### BACKGROUND

The subject matter of this application relates to a platform for uploading and delivering adaptive bitrate (ABR) content.

Streaming multimedia over wired and/or wireless networks has become ubiquitous, being readily accessible through the Internet or other network connections such as 4G, Bluetooth, etc. Because any given multimedia content stream may be requested by any one of a variety of devices, such as desktop computers, laptops, cell phones, tablets and so forth, each with its own display capabilities and over network bandwidth of varying quality, adaptive bit rate protocols have been established by which a particular multimedia device may receive streamed content at a quality appropriate for that device and its current network connection quality. For example, an ABR system may provide an on-demand movie to an HD television with a broadband connection to the Internet at 1080 p/4300 kbps and 5.1 surround audio while simultaneously delivering the same movie at 480 p/1050 kbps and stereo audio to a cell phone connected to the Internet over a 4G service. Alternately, that same cell phone could change from 480 p quality to 240 p quality, and back again, as bandwidth changes as, say, a user moves among wireless networks of disparate quality.

Several ABR technologies/formats currently exist, such as HTTP Live Streaming (HLS), MPEG Dash, Adobe HDS, etc. Using HLS as an example, HLS transcodes a particular multimedia presentation into a set of different streams of varying quality (each called a “variant”), where each variant may have a number of components (video, audio, etc.). The presentation is packaged into a number of segments to be delivered and played sequentially by a multimedia player, where each segment is hosted at one or more unique Universal Resource Locators (URLs) and comprises a transport stream file, usually having a transport stream (.ts) file extension, although other file formats may be used, such as fragmented MPEG 4 or ISBMFF (ISO Base Media File Format0, etc. The multimedia content provider than makes the presentation available by publishing two types of manifests. A top-level master manifest uniquely identifies a set of available variant multimedia streams, each of a particular published quality including an overall stream bitrate and a set of codecs used for video and audio, such as AVC for MPEG 4 video and AAC for audio. Each of these multimedia streams is then given one or more separate media manifests, or playlists, each sequentially identifying the URLs of files that together contain a component or set of components of the media presentation. For example one media manifest may specify URLs to a sequence of segments of the presentation that include the video presentation and its English audio while a second media manifest may specify URLs to a sequence of segments of the same presentation that only includes the Spanish audio for that presentation.

When a user selects a presentation for streaming to a device, that device retrieves the master playlist and selects the media stream having a quality that best matches the capabilities of the device as well as the bandwidth available to the device at that time. From that selection, the media manifest (playlist) associated with that stream is received by the player, which uses the playlist to sequentially retrieve and display the presentation segments from the URLs listed in the playlist. If conditions change, such that bandwidth drops below a level for acceptable playback of the content, the device can use the master playlist to select a lower quality multimedia stream, access the media manifest associated with that quality, and continue the presentation using the URLs from that manifest. Though HLS was used as an example to describe an adaptive bitrate system, other systems and formats operate in a similar fashion to deliver streaming content to a variety of devices, at selective bitrates and levels of quality.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary adaptive bitrate system.

FIG. 2 shows an exemplary system for transcoding content uploaded into an adaptive bitrate system.

FIG. 3 shows an exemplary system for delivering the transcoded content of FIG. 2.

### DETAILED DESCRIPTION

As previously noted, adaptive bitrate systems allow a content server to publish master and media manifest files for access by client devices. A master manifest file identifies multiple sets of video streams, or variants, for a media program such as a movie, a television program, etc., where each variant has unique encoding parameters (e.g., bit rates, resolutions, etc.) for the media program. The client devices may dynamically switch between the sets of variants identified in the master manifest file as the multimedia stream is transmitted from a content server to the client devices. The client devices may choose to receive an initial variant identified in the master manifest file based on initial network conditions, initial buffer conditions, etc. For example, the client devices may choose to receive a high definition presentation identified in a master manifest file if the initial network conditions, the initial buffer conditions, etc., support the streaming of high definition content. If those initial network conditions degrade, or if the initial buffer conditions degrade, etc., then the client devices may choose to receive a lower resolution presentation identified in the master manifest file. That is, the client device may dynamically choose different sets of variants to receive from the content server, where the different variants have different encoding parameters.

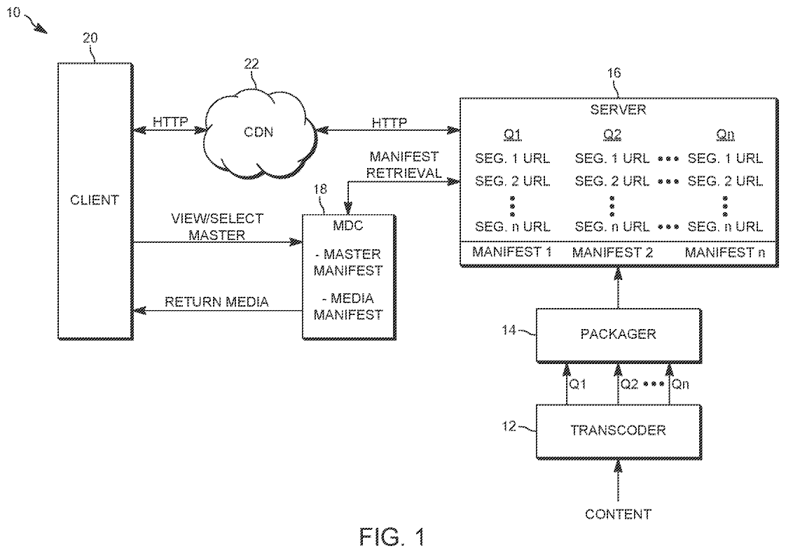

Referring to FIG. 1, for example, an adaptive bitrate system 10 may include a transcoder 12 that receives multimedia content and transcodes that content into a plurality of variant multimedia streams, each of a different quality Q, and forwards the variant streams to a packager 14. The packager 14, in turn, divides each variant stream into a plurality of sequential segments and forwards each segment to a server 16 such that each segment can be retrieved at its own unique URL. In addition, as the packager 14 segments each multimedia stream, the packager 14 creates the master manifest file and the playlist manifest files necessary to select and retrieve a multimedia stream of a desired quality, publishes those manifest files on the server 16, and updates each of those manifests as more of the content is transcoded.

An exemplary master manifest file may be as follows:

#EXTM3U
#EXT-X-VERSION:3
#EXT-X-STREAM-
INF:BANDWIDTH=878612,RESOLUTION=640x360,CODECS=“avc1.4D4029,mp4a.40.2”
scte35_1.m3u8
#EXT-X-STREAM-
INF:BANDWIDTH=2628628,RESOLUTION=1280x720,CODECS=“avc1.4D4029,mp4a.40.2”
scte35_2.m3u8
#EXT-X-STREAM-
INF:BANDWIDTH=1128660,RESOLUTION=854x480,CODECS=“avc1.4D4029,mp4a.40.2”
scte35_3.m3u8

The first line of the master manifest file is header indicating that the file format is the MPEG Layer 3 URL format. The EXT-X-VERSION tag indicates the compatibility version of the playlist manifest files listed in the master manifest, where “version 3” indicates the use of floating point values to specify the duration of each segment in the listed playlist manifest files. The exemplary master manifest file identifies three different playlist manifests, each of a described quality, as well as a URL to each playlist manifest. For example, the first playlist manifest is described in the master manifest as having an associated bandwidth of 876612 and a video resolution of 640×360, and specifies the video (AVC1 or H.264/MPEG-4) and audio (mp4a) codecs used as well as their quality. A link to the URL of the playlist manifest then follows, i.e. “scte35 1.m3u8.” This URL, as well as other URLs given in master and media playlists, are typically expressed as relative URLs, i.e. a URL that does not explicitly specify the protocol (e.g., “http://” or “https://”) and/or domain (www.server.com), which forces a visiting device or browser to assume the URL is hosted at the same site, subdirectory etc. on which the URL appears.

Each URL in the master manifest points to a separate playlist manifest, which in turn lists a series of URLs that each point to a sequential segment of the multimedia presentation for that playlist, of the quality specified for that playlist in the master manifest. An exemplary playlist manifest may be as follows:

#EXTM3U
#EXT-X-TARGETDURATION:10
#EXT-X-VERSION:3
#EXT-X-MEDIA-SEQUENCE:0
#EXTINF:9.97667,
file000.ts
#EXTINF:9.97667,
file001.ts
#EXTINF:9.97667,
file002.ts
#EXTINF:9.97667,
file003.ts
#EXTINF:9.97667,
file004.ts

In this exemplary playlist manifest, the “EXT-X-TARGETDURATION” specifies the maximum duration of any segment listed in the manifest (in this case 10 seconds), and the EXT-X-MEDIA-SEQUENCE indicates an identifying number of the first URL listed in the sequence (in this case “0”). The next two lines indicate a segment having a duration of 9.97667 seconds and gives the URL to that segment, i.e. “file000.ts.” Subsequent pairs of lines similarly identify the length of a segment and the URL to that identified segment.

When a client 20 wishes to receive a multimedia presentation, it may contact Multimedia Delivery Controller (MDC) 18. MDC 18 retrieves the master manifest for the presentation, which can be viewed by the client 20 so that it may select an appropriate one of the offered playlists delineated in the master manifest. Upon selection, the MDC 18 retrieves the media playlist (i.e., a second-level manifest) for that selection and forwards it to the client 20. The client 20 then uses the URLs specified in the media playlist to retrieve the content segments directly from the server 16 through a content delivery network 22, such as the Internet.

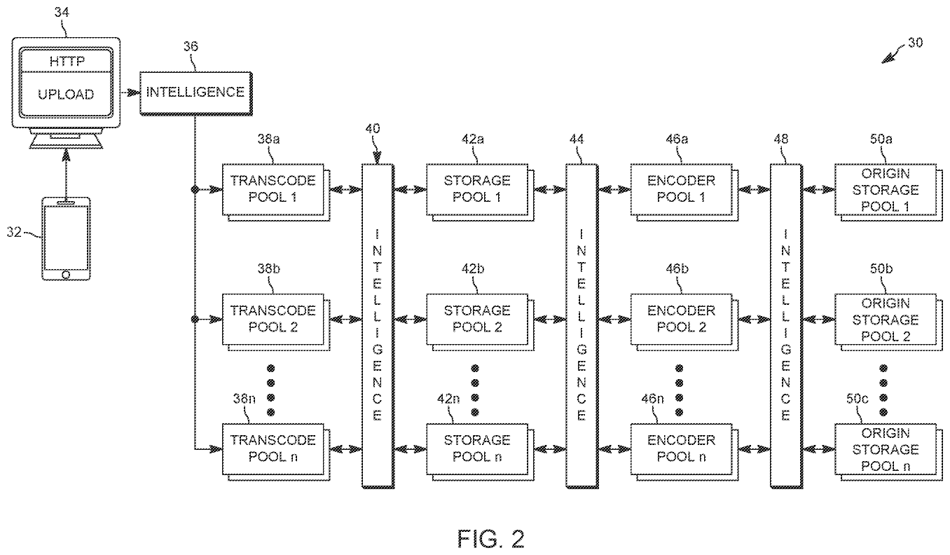

Currently, providers of adaptive bitrate content rely upon multiple systems to upload, encode, and deliver their content to consumers. FIG. 2 shows an exemplary integrated cloud-based video management platform 30 capable of receiving content from a provider and delivering it to a customer. In the system 30, a content provider may use local computing device 32 such as a desktop, laptop, PDA etc. to contact an upload server 34 that presents a user interface allowing the content provider to upload the desired content. The server 34 preferably includes or is otherwise connected to a processing device 36 that receives the uploaded content and transcodes it into respectively different transcoded pools 38a to 38n. The server 34/processing device 36 is preferably configured to receive content in any of a wide number of content formats, and transcode the content into a first, or intermediate format. In some preferred embodiments, the processor 36 implements an intelligent, machine-learning algorithm that auto detects the properties of the uploaded content and selects the transcoder 38a to 38n that is best able to transcode the content according to any one or more of a number of factors, e.g. CPU load on the transcoder, the number of active, completed, and in-process requests in a queue, the length of transcoded video, the ABR format of the video (e.g., HLS/DASH), storage/RAM availability, etc. and intelligently determine and select a transcoder pool that can transcode the content the most quickly.

During transcoding, intelligence 40, which in some embodiments may be the processor 36 directs the transcoded content to a selected one of storage pools 42a to 42n. In some preferred embodiments, the intelligence 40 implements an intelligent, machine-learning algorithm that auto detects the properties of the transcoded content and selects the storage pool 42a to 42n that is the best storage solution for the particular content according to any one or more of a number of factors. For example, storage pools may be categorized by popularity or use, e.g. one storage pool may be a short term storage pool for trending or otherwise popular content while another storage pool may be for long-term or persistent content, with any number of gradations in between. Alternatively, or additionally, storage pools may be based on geography where content is stored in storage pools closest to a client 20. In some embodiments, where there are a plurality of servers that serve as a storage pool in each category, when a new request is received from a client 20, a Machine Learning algorithm may use multiple factors to intelligently determine and selects a storage pool and/or server that helps to deliver a quality and lag-free viewing experience to the client 20, including but not limited to available storage capacity, the number of active, completed, and in-process queuing of incoming content view requests, CPU load, proximity of the storage pool to the client 20, and the nature of content request (e.g., if it is a currently trending popular content, or an old classic). Once the content is stored in an intermediate format, intelligence 44 may encode the content from the intermediate format into a final format, such as a .ts format, and store the content in a selected one of origin storage pools 50a to 50c.

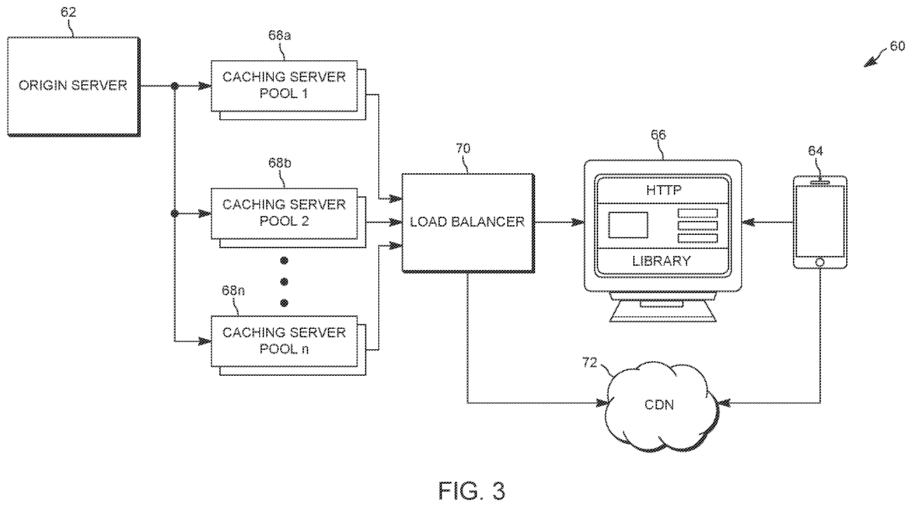

FIG. 3 shows a system by which consumers may access content provided from an origin server 62 using client-devices 64. The origin server 62, which hosts storage pools 50a to 50n shown in FIG. 2, provides the content to a content library 66 via a load balancer 70 via caching server pools 68a to 68n. In some preferred embodiments, the origin server 62 implements an intelligent, machine-learning algorithm that detects and loads content to nearest caching streamer for smooth lag free viewing experience.

The content library 66 preferably provides a user interface to client devices 64 by which consumers can browse and select desired content via, e.g. thumbnails. In some embodiments, for example, the library 66 may present a user interface allowing users to scroll through available content on one side of a display while showing selected content in a central portion of a display. In some embodiments, the library 66 acts as a manifest delivery controller such that, when content is selected by a consumer the device 64 may select a transport stream with the appropriate bit rate, resolution, etc. which may then be streamed for viewing by the consumer. In some embodiments, the content may be viewed in a display shown through the library 66, e.g. in a web browser with available content shown to a user while selected content is being streamed to facilitate easy switching from one piece of content to another. In other embodiments, the streamed content may be provided directly to client devices 64 via CDN 72 for display on the devices 64 using onboard media software.

The load balancer 70 preferably apportions content from the caching server pools 68a to 68n to the library 66 and/or CDN 72 in response to the varying requests from the library 66. In some other embodiments, the load balancer 70 may apportion content from the caching server pools 68a to 68n to the library 66 and/or CDN 72 in response to requests originating from a third party Content Delivery Network such as Akamai, AWS.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A system comprising:
a processing device capable of receiving multimedia content in each of a plurality of different first formats, transcoding the content into an intermediate format, transcoding the content from the intermediate format to each of a plurality of different second formats, and storing the content in each of the plurality of second formats;
a library that displays the multimedia content to a consumer in a manner that the multimedia content is individually selectable by the user, selection causing the content to be streamed to the user.

2. The system of claim 1 including a plurality of transcoders and the processing device automatically selects from among the plurality of transcoders to transcode the multimedia content.

3. The system of claim 2 where selection is based on a machine learning algorithm.

4. The system of claim 1 including an origin server that caches the multimedia content in a selected one or more of a plurality of caching pools.

5. The system of claim 4 including a load balancer controls the transfer of content from among the plurality of caching pools to at least one of the library and a content delivery network.

6. The system of claim 1 where the library is capable of both presenting content to the consumer for selection, and displaying a video stream of the selected content.

7. The system of claim 1 capable of providing adaptive bit rate content.

8. A method comprising:
receiving multimedia content in each of a plurality of different first formats;
transcoding the content into an intermediate format;
transcoding the content from the intermediate format to each of a plurality of different second formats;
storing the content in each of the plurality of second formats; and
displaying the multimedia content to a consumer in a library in a manner that the multimedia content is individually selectable by the user, selection causing the content to be streamed to the user.

9. The method of claim 8 including automatically selects from among a plurality of transcoders to transcode the multimedia content.

10. The method of claim 9 where selection is based on a machine learning algorithm.

11. The system of claim 8 including caching the multimedia content in a selected one or more of a plurality of caching pools.

12. The system of claim 11 including balancing a load from among the plurality of caching pools to at least one of the library and a content delivery network.

13. The method of claim 8 where the library is capable of both presenting content to the consumer for selection, and displaying a video stream of the selected content.

14. The method of claim 8 capable of providing adaptive bit rate content.
